(19) United States
(12) Patent Application Publication
(10) Pub. No.: US 2026/0138028 A1
(43) Pub. Date: May 21, 2026

(54) SYSTEM FOR MUSIC ENABLED GAMES PLATFORM FOR IN-VEHICLE GAMING WHILE DRIVING FOR VEHICLE PASSENGERS

(71) Applicant: FCA US LLC, Auburn Hills, MI (US)

(72) Inventors: Amit Mehta, Auburn Hills, MI (US); Pravin Chopade, Auburn Hills, MI (US)

(21) Appl. No.: 18/954,621

(22) Filed: Nov. 21, 2024

(51) Int. Cl. A63F 13/65; A63F 13/216; A63F 13/54; A63F 13/67; A63F 13/803

(52) U.S. Cl. CPC A63F 13/65; A63F 13/216; A63F 13/54; A63F 13/67; A63F 13/803

(57) ABSTRACT

A music enabled games platform for use in a vehicle by vehicle occupants including at least a driver and a first non-driving passenger includes an in-vehicle platform interface, a first display, a second display, sensors and a controller. The first display is configured on a vehicle infotainment system of the vehicle, the vehicle infotainment system supplying a music output to the vehicle occupants. Sensors receive a music signal based on the music output. The controller receives the music signal; extracts features from the music signal including at least one of tempo, rhythm, and mood; communicates the extracted features to a data analytics infrastructure that associates a modified characteristic of the game selection including at least one of a speed of gameplay and an intensity of in-game events with the extracted features; and modifies play of the selected game based on the modified characteristic.

### FIELD

The present application generally relates to a vehicle integrated interactive gaming system for use by vehicle passengers.

### BACKGROUND

Traditional in-vehicle entertainment systems primarily focus on providing audio and video content for the driver, often neglecting the passengers. While drivers often have access to audio systems, navigation aids, and limited infotainment options, passengers lack dedicated and engaging entertainment, leading to boredom and dissatisfaction during journeys. As a result, there is a lack of dedicated gaming experiences tailored for in-vehicle environments, especially for vehicle passengers. Moreover, existing solutions do not effectively utilize the potential for interactive and engaging experiences for drivers, which could enhance the overall in-vehicle entertainment for vehicle passengers. Accordingly, while such in-vehicle entertainment systems do work well for their intended purpose, there is a desire for improvement in the relevant art.

### SUMMARY

According to one example aspect of the invention a music enabled games platform for use in a vehicle by vehicle occupants including at least a driver and a first non-driving passenger includes an in-vehicle platform interface, a first display, a second display, sensors and a controller. The first display is configured on a vehicle infotainment system of the vehicle, the vehicle infotainment system supplying a music output to the vehicle occupants. The second display is configured in the vehicle for use with the first non-driving passenger. Sensors receive a music signal based on the music output. The controller receives the music signal; extracts features from the music signal including at least one of tempo, rhythm, and mood; communicates the extracted features to a data analytics infrastructure that associates a modified characteristic of the game selection including at least one of a speed of gameplay and an intensity of in-game events with the extracted features; and modifies play of the selected game based on the modified characteristic.

In some implementations, the sensors further include a vehicle speed sensor that senses vehicle speed, wherein the controller further: modifies play of the selected game based on the vehicle speed.

In some implementations, the controller further: adjusts parameters of the selected game including a complexity of game challenges.

In some implementations, the controller further: adjusts parameters of the selected game including a frequency of in-game events.

In some implementations, the sensors further include at least one of an advanced driver assistance system, an anti-lock brake system and wheel speed sensor that output a driving condition parameter, wherein the controller further: adjusts parameters of the selected game based on the driving condition parameter.

In additional aspects, the music enabled games platform further includes a music synchronization module that receives the music signal, analyzes the music signal and synchronizes gameplay of the selected game based on the music signal.

In additional features, the music enabled games platform further includes a safety module that implements adaptive gameplay based on vehicle speed.

In examples, the music enabled games platform further includes a game recommendation engine that implements personalized learning and vehicle customer modeling (PLVCM) based on analysis of gameplay of the selected game and that provides recommendations based on the analysis.

In additional features, the second display is disposed on a headrest of the vehicle.

In other features, the second display is one of a tablet, computer and phone.

In additional aspects, the music enabled games platform further includes a first gaming controller configured for use with the first non-driving passenger on the second display

In other features, the music enabled games platform further includes a third display configured in the vehicle for use with a second non-driving passenger. It will be appreciated that multiple non-driving passengers can use the music enabled games platform.

In additional implementations, the sensors further include a position sensor that cooperates with a global positioning service (GPS) to identify a vehicle location, wherein the controller modifies play of the selected game based on the vehicle location.

In additional embodiments, the in-vehicle platform interface grants interactive access with the selected game to the first non-driving passenger subsequent to game selection.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic illustration of an example design architecture for a music enabled games platform according to various principles of the present application;

FIG. 2 is schematic illustration of an exemplary head unit that implements the music enabled games platform according to examples of the present application;

FIG. 3 is an exemplary in-vehicle display interface and showing various applications according to examples of the present application;

FIG. 4 is an exemplary in-vehicle display interface and showing various available game applications within the games selection of FIG. 3 according to examples of the present application;

FIG. 5 shows exemplary entertainment screens used with the music enabled games platform, the entertainment screens including a driver accessible screen and first and second passenger accessible screens; and

FIG. 6 is a schematic illustration of an exemplary cloud connectivity website portal and vehicle client gaming platform according to additional features of the present application.

### DESCRIPTION

As discussed above, traditional in-vehicle entertainment systems primarily focus on providing audio and video content for the driver, often neglecting the passengers. As a result, there is a lack of dedicated gaming experiences tailored for in-vehicle environments, especially for vehicle passengers. Moreover, existing solutions do not effectively utilize the potential for interactive and engaging experiences for drivers, which could enhance the overall in-vehicle entertainment for passengers. Furthermore, traditional in-vehicle entertainment systems typically do not integrate music and gaming in a synchronized manner. This lack of cohesion diminishes the potential for a truly immersive and enjoyable entertainment experience. In addition, current solutions do not adequately address safety concerns related to gaming in a moving vehicle. Distractions for both drivers and passengers are not effectively mitigated, potentially compromising road safety.

The instant disclosure provides a system for a music enabled games platform for in-vehicle entertainment. The system caters to the entertainment needs of vehicle passengers, providing an interactive and immersive gaming experience that reacts to sensed data seamlessly integrated with music playback. As will be described in detail herein, the system provides various features including: a music-driven gaming experience; safety measures; multi-player interaction; adaptive game selection; a customer-friendly interface; and integration with vehicle systems.

The music-driven gaming experience leverages the vehicle's audio system to synchronize gameplay with the music being played, creating a dynamic and responsive gaming environment. To ensure the safety of the driver and passengers, the system incorporates intelligent sensors and algorithms that automatically adjust the gaming intensity and complexity based on the vehicle's speed, traffic conditions, and other safety parameters. The system supports multiplayer gaming experiences, enabling passengers to engage in collaborative or competitive games during the journey, fostering social interaction and entertainment. The system employs machine learning algorithms to analyze passengers'preferences, previous gaming history, and music choices to recommend and adaptively select games that align with the passengers'interests. The system provides a customer-friendly interface, possibly with voice commands or touch controls, allowing easy navigation through the gaming library, ensuring a seamless and enjoyable customer experience. The system integrates with the vehicle's infotainment system, utilizing existing display screens and controls for a unified and convenient gaming experience.

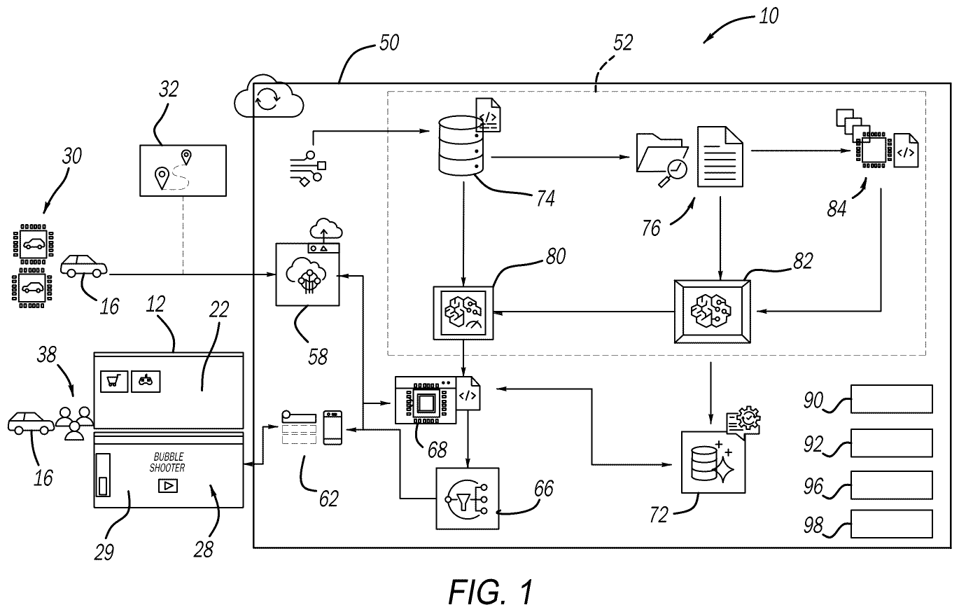

Referring now to FIG. 1, a functional block diagram of an example music enabled games platform is shown and generally identified at reference numeral 10. The music enabled gaming platform 10 generally includes a controller 12 that implements the music enabled gaming platform 10 within a vehicle 16. In examples, the controller 12 communicates with an in-vehicle gaming platform interface 22. The in-vehicle platform interface 22 can be implemented such as on a screen or display 24 of a vehicle infotainment system 28. As will become appreciated herein, the music enabled gaming platform 10 is configured to operate with other connected vehicles 30. In examples, a global positioning service (GPS) 32 can be used to locate other connected vehicles 30 and to announce a users' location to other perspective gamers. In the example shown, in-vehicle gamers, collectively identified at 38 are able to access and interact with the in-vehicle platform interface 22 to play games in the vehicle 16.

The vehicle 16 that implements the music enabled gaming platform 10 communicates with a cloud platform 50 having a data analytics infrastructure 52. In examples, the cloud platform 50 can include an internet of things (IoT) core hub 58, an application data/camera sensors data stream 60, and an HTTP interface/mobile client 62. An event/message notification service 66 communicates with the HTTP interface/mobile client 62. An event-driven serverless computing platform 68 communicates with the event/message notification service 66. A personalized safety messages, music, games recommendation module 72 communicates with the event-driven serverless computing platform 68. The data analytics infrastructure 52 includes vehicle incoming telematics engine control unit and sensor data module 74, an analysis, processing and training module 76, a customer audio analysis (CAA) adaptive safety and personalized games selection model algorithm 80, an artificial intelligence machine learning (AI-ML) based personalized learning and vehicle customer modeling (PLVCM) 82, and a PLVCM instances module 84. The PLVCM 82 provides a recommendation model and analytics platform integrated in the cloud 50 for online and off-line player interaction data analysis.

In examples, the CAA 80 implements an algorithm that analyzes the audio input from the vehicle's music system in real-time. Tempo, rhythm, and mood features are extracted from the music signal. Game elements, such as the speed of gameplay or the intensity of in-game events are dynamically adjusted based on the extracted features. In examples, the adjusted gameplay speed can be a function of tempo, rhythm and mood. The adaptive safety portion of the algorithm 80 includes sensors that continuously monitor the speed of the vehicle 16, location, such as with the GPS 32, and driving conditions. The algorithm 80 adjusts gaming parameters, such as the complexity of challenges or the frequency of in-game events, based on the real-time data. Safety thresholds are defined to ensure that the gaming experience remains within safe limits. In examples, the adjusted gaming complexity can be a function of vehicle speed and driving conditions.

The music enabled gaming platform 10 supports collaborative and competitive multiplayer gaming experiences. Passengers 38 can engage in social and interactive gaming sessions during the journey, fostering a sense of shared entertainment.

The personalized safety messages, music, games recommendation module 72 implements advanced machine learning algorithms that analyze historical gaming data, individual preferences, and music choices to create customer profiles. Similarities between customer/user profiles and available games are calculated. Games are recommended or adaptively selected based on the calculated similarities. In examples, a personalized game recommendation score can be a function of the historical gaming data, individual preferences and music choices.

The music enabled gaming platform 10 provides seamless integration with the existing audio and control systems of vehicle 16 utilizing display screens, speakers and customer/user interfaces. This provides a customer-friendly and convenient gaming experience.

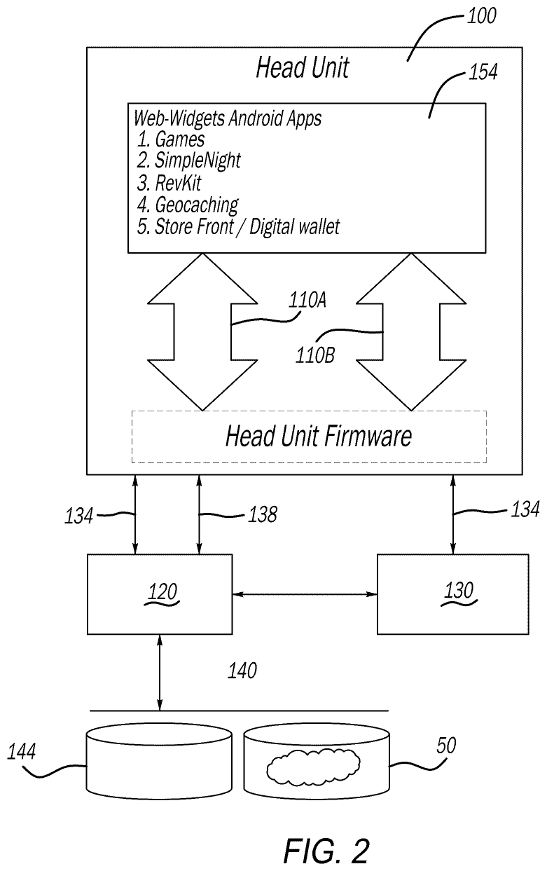

The music enabled gaming platform 10 is shown including a music synchronization module 90, a safety module 92, a game recommendation engine 96 and a multi-player module 98. Any or all of the modules 90-98 can be implemented anywhere in the music enable gaming platform 10, such as at the vehicle 16 and/or the cloud 50 for analyzing sensor data such as at the controller 12. The music synchronization module 90 can implement artificial intelligence, machine learning based algorithms for analyzing music and synchronizing with gameplay. The safety module 92 can implement adaptive mechanisms based on driving conditions. The game recommendation engine 96 can implement advanced PLVCM algorithms for personalized game selection. The multi-player module 98 can support collaborative and competitive gaming. The music enabled gaming platform 10 also shows integration R1H Head Unit 12, FIG. 2. 100 with Cloud through API Gateway, with Web-Portal Game Engine with Video Encoder, Music, customer/user data collection and processing. This platform integrates music-driven synchronization algorithm-customer audio analysis (CAA), adaptive safety mechanism algorithm and personalized game selection algorithm advanced PLVCM.

Turning now to FIG. 2, additional features of the music enabled gaming platform 10 will be described. FIG. 2 is schematic illustration of an exemplary head unit 100 that implements the music enabled games platform 10 according to examples of the present application. The head unit 100 can communicate with firmware 106 by way of an application programming interface (API). A first application programming interface is identified at 110A. A second application programming interface is identified at 110B. The first programming interface 110A can be a first language, while the second programming interface 110B can be a second language. It is contemplated that one or many API's can be incorporated. The head unit 100 can communicate with a TBM (Telematics Box Module) 2.0, TMB 2.0H 120 and a body control module 130.

In examples the head unit 100 can communicate with the TBM 2.0, TMB 2.0H 120 over a controller area network (CAN) 134. The TBM 120 acts as a modem providing internet connectivity to head unit 100 (a pass-through). Web Widget apps 154 goes through Access Point Name (APN3) network protocol for data traffic server. The CAN 134 may include additional elements or features, which have been omitted for simplicity, such as controllers, buffers (cache) drivers, repeaters and receivers, among many others, to enable communications. Further, the CAN 134 may include address, control and/or data connections to enable appropriate communications among the components/systems described herein. The head unit 100 can additionally or alternatively communicate with the TBM 2.0,TMB 2.0H 120 through ethernet 138. The TBM 2.0, TMB 2.0H 120 communicates over a data traffic layer/website widget application programming interface gateway 140 to an eligibility layer data store 144 and the cloud 50. The head unit 100 and applications 154 collectively provide application programing interface for seamless integration with the vehicles audio, display and control systems.

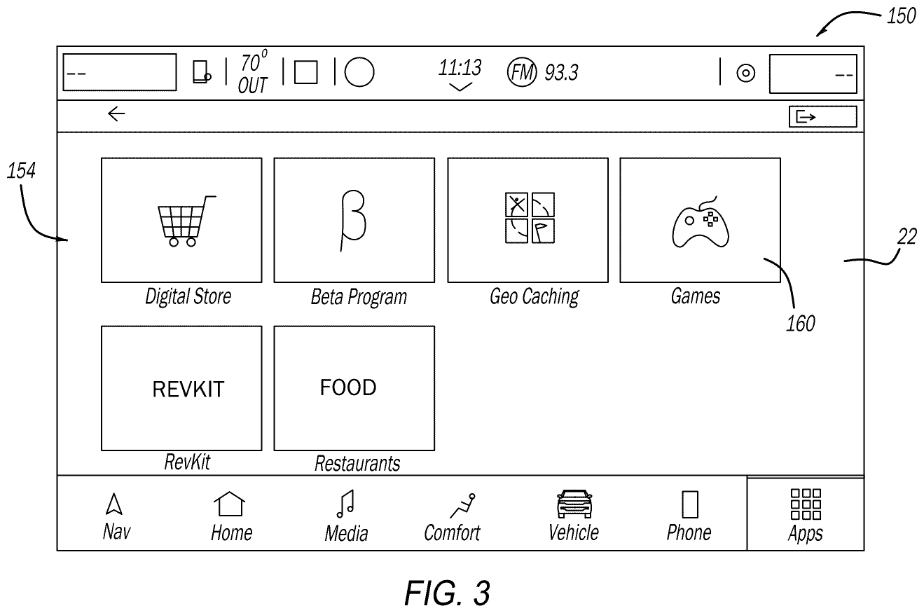

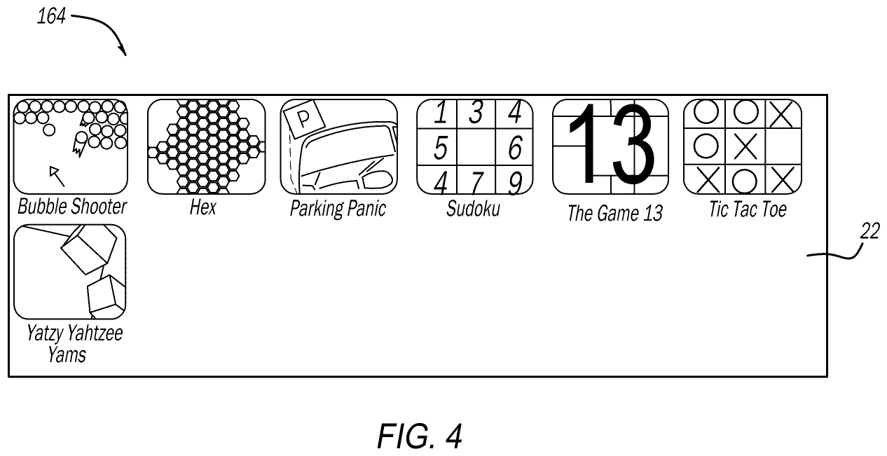

With additional reference to FIGS. 3 and 4, additional features of the in-vehicle gaming platform interface 22 will be described. As shown on FIG. 3, the in-vehicle platform interface 22 is shown implemented as a collage of general application icons 154 on the display 24 of the vehicle infotainment system 28. In the example shown, one of the application icons 154 includes a Games icon 160. FIG. 4 shows an exemplary in-vehicle gaming platform interface 22 showing various available game applications 164 subsequent to selecting the games application 160 of FIG. 3.

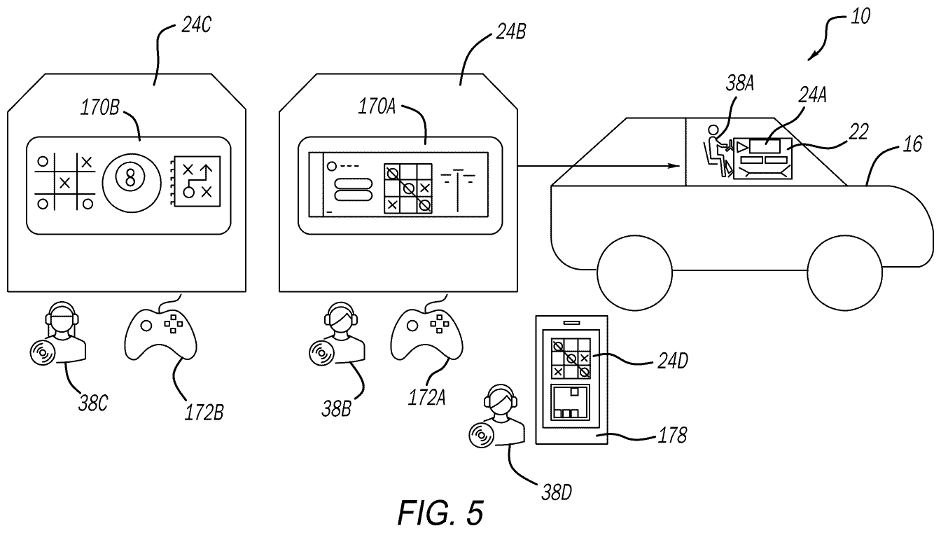

FIG. 5 shows exemplary entertainment screens used with the music enabled games platform 10, the entertainment screens including a driver accessible screen 24A a first passenger accessible screen 24B, a second passenger accessible screen 24C, and a third passenger accessible screen 24D. It will be appreciated that additional (or fewer) screens may be provided within the scope of the present disclosure. In examples, the driver accessible screen 24A can provide the in-vehicle gaming platform interface 22 for giving Game access to the passengers 38B-38D without distraction to the driver 38A. In examples, the first passenger accessible screen 24B can include game client video decoder and video display 170A while the second passenger accessible screen 24C can include game client video decoder and video display 170B. A first gaming controller 172A is shown associated with the first passenger 38B. A second gaming controller 172B is shown associated with the second passenger 38C. The first and second passenger accessible screens 24B and 24C can be implemented on displays integrated or otherwise coupled to the vehicle 16 (e.g., such as at a headrest). The third passenger accessible screen 24D is shown implemented onto a tablet 178. It is appreciated that any combinations of the accessible screens can be integrated onto vehicle hardware and/or passenger supplied devices (tablet, computer, phones, etc.).

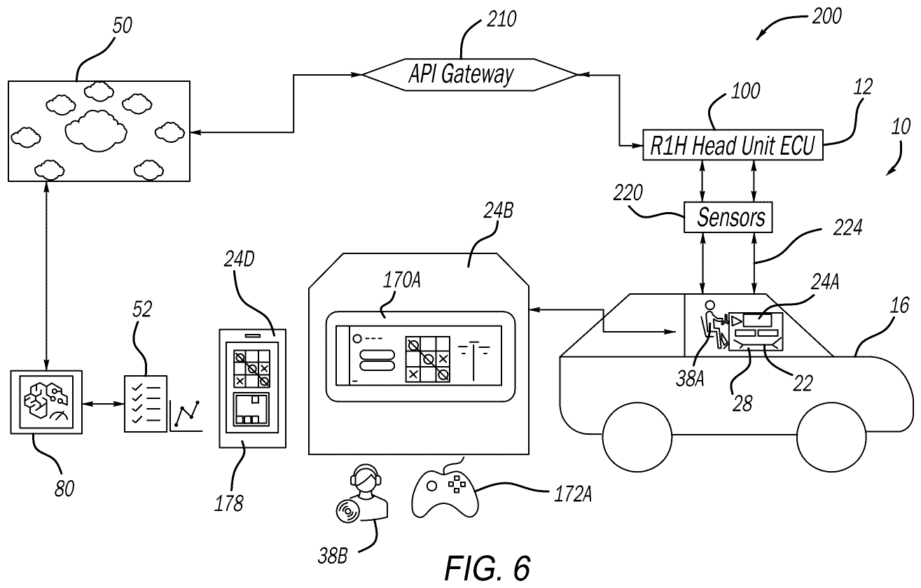

FIG. 6 is a schematic illustration of an exemplary cloud connectivity website portal and vehicle client gaming platform 200 according to additional features of the present application. The cloud connectivity website portal and vehicle client gaming platform 200 includes an application programming interface gateway 210 that communicates between the cloud 50 and the head unit 100. Sensors 220 communicate signals to the controller 12. In examples the sensors 220 include one or more sensors that extract tempo, rhythm and mood from a music signal 224. In implementations, the music signal 224 can be extracted from the infotainment system 28. As explained above, game elements, such as the speed of gameplay or the intensity of in-game events are dynamically adjusted based on the extracted features including at least one of tempo, rhythm and mood.

In other implementations, the sensors 220 can include a speed sensor, a location sensor and a driving condition sensor. The speed sensor can be any speed sensor (e.g., wheel speed sensor or GPS enabled speed) that communicates a speed of the vehicle 16 to the controller 12. The location sensor can be any location enabling device such as the GPS 32. The driving condition sensor can be any sensor (e.g., such as associated with an advanced driver assistance system (ADAS), anti-lock brake system, wheel speed sensors, weather information and or driving conditions obtained through the cloud 50) capable of communicating driving conditions. As outlined above, the algorithm 80 of the music enabled gaming platform 10 adjusts gaming parameters, such as the complexity of challenges or the frequency of in-game events, based on the real-time data communicated by the sensors 220. Safety thresholds are defined to ensure that the gaming experience remains within safe limits. In examples, the adjusted gaming complexity can be a function of vehicle speed and driving conditions.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A music enabled games platform for use in a vehicle by vehicle occupants including at least a driver and a first non-driving passenger, the music enabled games platform comprising:
an in-vehicle platform interface that receives user inputs indicative of a game selection, the in-vehicle platform interface executing the game selection for use by the vehicle occupants;
a first display configured on a vehicle infotainment system of the vehicle, the vehicle infotainment system supplying a music output to the vehicle occupants;
a second display configured in the vehicle for use with the first non-driving passenger;
sensors that receive a music signal based on the music output; and
a controller that:
receives the music signal;
extracts features from the music signal including at least one of tempo, rhythm, and mood;
communicates the extracted features to a data analytics infrastructure that associates a modified characteristic of the game selection including at least one of a speed of gameplay and an intensity of in-game events with the extracted features; and
modifies play of the selected game based on the modified characteristic.

2. The music enabled games platform of claim 1, wherein the sensors further include a vehicle speed sensor that senses vehicle speed, wherein the controller further:
modifies play of the selected game based on the vehicle speed.

3. The music enabled games platform of claim 2, wherein the controller further:
adjusts parameters of the selected game including a complexity of game challenges.

4. The music enabled games platform of claim 2, wherein the controller further:
adjusts parameters of the selected game including a frequency of in-game events.

5. The music enabled games platform of claim 2, wherein the sensors further include at least one of an advanced driver assistance system, an anti-lock brake system and wheel speed sensor that output a driving condition parameter, wherein the controller further:
adjusts parameters of the selected game based on the driving condition parameter.

6. The music enabled games platform of claim 1, further comprising:
a music synchronization module that receives the music signal, analyzes the music signal and synchronizes gameplay of the selected game based on the music signal.

7. The music enabled games platform of claim 1, further comprising:
a safety module that implements adaptive gameplay based on vehicle speed.

8. The music enabled games platform of claim 1, further comprising a game recommendation engine that implements personalized learning and vehicle customer modeling (PLVCM) based on analysis of gameplay of the selected game and that provides recommendations based on the analysis.

9. The music enabled games platform of claim 1, wherein the second display is disposed on a headrest of the vehicle.

10. The music enabled games platform of claim 1, wherein the second display is one of a tablet, computer and phone.

11. The music enabled games platform of claim 1, further comprising:
a first gaming controller configured for use with the first non-driving passenger on the second display.

12. The music enabled games platform of claim 1, further comprising:
a third display configured in the vehicle for use with a second non-driving passenger.

13. The music enabled games platform of claim 1, wherein the sensors further include a position sensor that cooperates with a global positioning service (GPS) to identify a vehicle location, wherein the controller modifies play of the selected game based on the vehicle location.

14. The music enabled games platform of claim 1, wherein the in-vehicle platform interface grants interactive access with the selected game to the first non-driving passenger subsequent to game selection.
